(19) United States
(12) Patent Application Publication
(10) Pub. No.: US 2011/0271029 A1
(43) Pub. Date: Nov. 3, 2011

(54) HOST SYSTEM AND DATA TRANSMISSION CIRCUIT THEREOF

(75) Inventor: Chien-Kuan HO, Santa Ana, CA (US)

(73) Assignee: I/O INTERCONNECT, LTD.

(21) Appl. No.: 12/770,647

(22) Filed: Apr. 29, 2010

(51) Int. Cl. G06F 13/20

(52) U.S. Cl. 710/313

(57) ABSTRACT

A data transmission circuit is provided by the present invention with a PCIe slot unit and a PCIe I/O interface card. Wherein the PCIe I/O interface card is inserted into the PCIe slot unit and coupled to a peripheral apparatus through a PCIe connection device. Therefore, a transmission data can be transmitted between the PCIe I/O interface card and the PCIe slot unit through the PCIe connection device.

### BACKGROUND

1. Technical Field

The present relates to a data transmission circuit, and more particularly to a data transmission circuit with a PCI express (PCIe) interface.

2. Description of the Related Art

The universal serial bus (USB) used wildly in computer is a serial bus standard for connecting external devices. Currently, the newest specification of the USB is USB 3.0 Standard. However, there is no any updated design for prior mother board in computer in accordance to the USB 3.0 Standard. One of the reasons is that when the hardware specification of the mother board is changed for USB 3.0 Standard, the cost of the hardware would be increased.

Therefore, the prior solution is shown in FIG. 1, which is a block diagram of a card reader system of prior computer system with USB 3.0 Standard transmission interface. Referring to FIG. 1, the prior card reader system 100 comprises a PCIe slot unit 102. Furthermore, there is a USB 3.0 interface card inserted into the PCIe slot unit 102. In addition, the USB 3.0 interface card is coupled to a card reader 108 via a USB 3.0 line 106. When a memory card (not shown) is inserted into the card reader 108, the USB 3.0 line would be used for transmitting data between the USB 3.0 interface card 104 and the card reader 108. Thus, the mother board in prior computer also supports using of components designed for USB 3.0 Standard.

However, there are some drawbacks in the prior manner. When the card reader 108 reads a read data from the memory card, the read data is transmitted to the USB 3.0 interface card 104 through the USB 3.0 line 106. Afterwards, the read data is transmitted to the PCIe slot unit 102. Relatively, when a written data will be written in the memory card inserted in the card reader 108, the written data would be transmitted to the USB 3.0 interface card 104 from the PCIe slot unit 102, and then to the card reader 108 via the USB 3.0 line 106.

As described above, both read data and written data are converted between two data formats of the PCIe and USB 3.0 Standard. Such format conversion would increase the loss of data transmission and decrease the data transmission rate.

### BRIEF SUMMARY

Accordingly, the present invention provides a data transmission circuit and a host system that not only reduces the loss of data transmission, but also prevents decreasing of data transmission rate.

A data transmission circuit provided by the present invention comprises a PCI express (PCIe) slot unit, a PCIe connection device and a PCIe I/O interface card. Wherein the PCIe I/O interface card is inserted into the PCIe slot unit and coupled to a peripheral apparatus through the PCIe connection device. Therefore, a transmission data can be transmitted between the PCIe I/O interface card and the PCIe slot unit through the PCIe connection device.

In one embodiment, a host system having a mother board with PCIe provided by the present invention comprise a control module, a PCIe module, a PCIe connection device, and a peripheral apparatus. The control module and the PCIe module both are disposed on the mother board and is electrically connected to each other for transmitting data. Furthermore, the PCIe module is further coupled to the peripheral apparatus through the PCIe connection device. Therefore, a transmission data can be transmitted between the PCIe module and the PCIe slot unit through the PCIe connection device.

In some embodiments of the present invention, the peripheral apparatus is a card reader has a memory card slot, and the specification of the memory card slot conforms to at least one of specifications of memory cards.

Due to the data transmission in the present invention is via PCIe transmission interface, no data format conversion is needed in the present invention. Thus, the data transmission loss can be reduced and the data transmission rate can be maintained.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of a card reader system of prior computer system with transmission interface designed for USB 3.0 Standard.

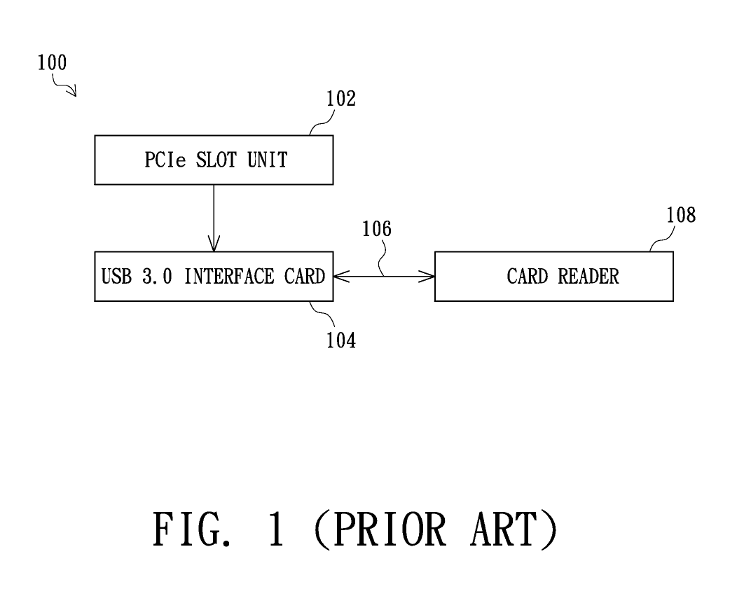

FIG. 2 is a circuit block diagram of a host system according to a preferred embodiment of the present invention.

FIG. 3 is a circuit block diagram of a control module according to a preferred embodiment of the present invention.

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

The present invention transmits data by using the transmission paths with the same data format so as to decrease the data transmission loss and maintain data transmission rate.

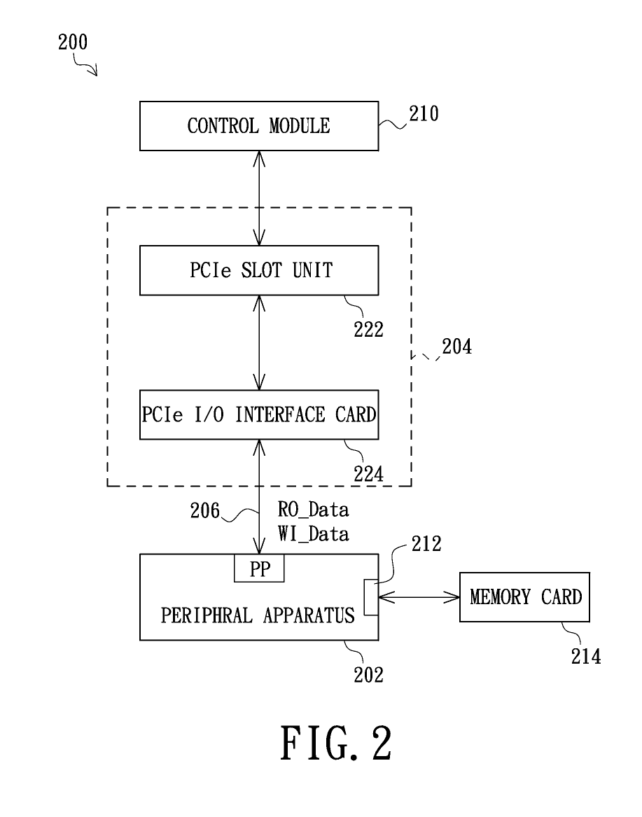

FIG. 2 is a circuit block diagram of a host system according to a preferred embodiment of the present invention. Referring to FIG. 2, a host system 200 provided in this embodiment comprises a peripheral apparatus 202 and a data transmission circuit for the peripheral apparatus 202. The data transmission circuit includes a PCIe module 204 and PCIe connection device 206. Wherein, the host system 200 may be a computer. In other embodiments the host system 200 may be a portable apparatus, such as a mobile phone, a smart phone, an electronic book, a package computer, a personal digital assistant etc.

In some embodiments, the peripheral apparatus 202 is a card reader having at least one memory card slot 212. Wherein, the specification of the memory card slot 212 conforms to at least one of specifications of memory cards, such as a PCMCIA card, CF card (type 1 and 2), SD card, mini SD card, micro SD card, SDHC card, T flash card, MMC card, RS-MMC card, MS card (Pro, Pro Duo, and micro), SM card, xD card, SDXC card, MS XC card, and etc.

In addition, the peripheral apparatus 202 further comprises a PCIe port PP for coupling with the PCIe connection device 206. Therefore, a transmission, such as a read data RO_Data or written data WI_Data, is transmitted between the peripheral apparatus 202 and PCIe module 204 through the PCIe connection device 206. In this embodiment, the PCIe connection device 206 is a PCIe bus. In alternative embodiments, the PCIe device is a flexible circuit board with PCIe specification. Moreover, the PCIe module 204 is coupled to a control module 210 of the host system 200.

The PCIe module 204 comprises a PCIe slot unit 222 which may be disposed on a mother board (not shown) in some embodiments. In addition, the PCIe module 204 further comprises a PCIe I/O interface card 224 inserted in the PCIe slot unit 222 in the embodiment shown in FIG. 2. The PCIe I/O interface card 224 is coupled to the peripheral apparatus 202 through the PCIe connection device 206.

In one embodiment, the peripheral apparatus 202 is a card reader so that when a memory card 214 is inserted into the memory card slot 212 of the card reader 202, the PCIe module 204 reads out a read data RO_Data from the memory card 214 inserted into the card reader 202. When the read data RO_Data is read out from the memory card 214, it is transmitted to the PCIe connection device 206 through the PCIe port PP. Then, the PCIe I/O interface card 224 receives the read data RO_Data from the PCIe connection device 206 and transmits the read data RO_Data to the control module 210 through the PCIe slot unit 222 for further processing. Similarly, when a written data WI_Data would be written into the memory card 214 by the control module 210, the written data WI_Data is transmitted to the card reader 202 through the PCIe slot unit 222, PCIe I/O interface card 224 and PCIe connection device 206 sequentially so as to write the written data WI_Data into the memory card 214 in the card reader 202.

Architecture of the control module 210 will be described in more detail by referring to a computer system in the following paragraphs. One skilled in the art should understand that different architecture of control module 210 can be used for different host system or even different architecture of control module 210 can be used for the same computer system. However, once the architecture of the control module 210 doesn't affect the operation described above, it doesn't affect the scope of the present invention, either.

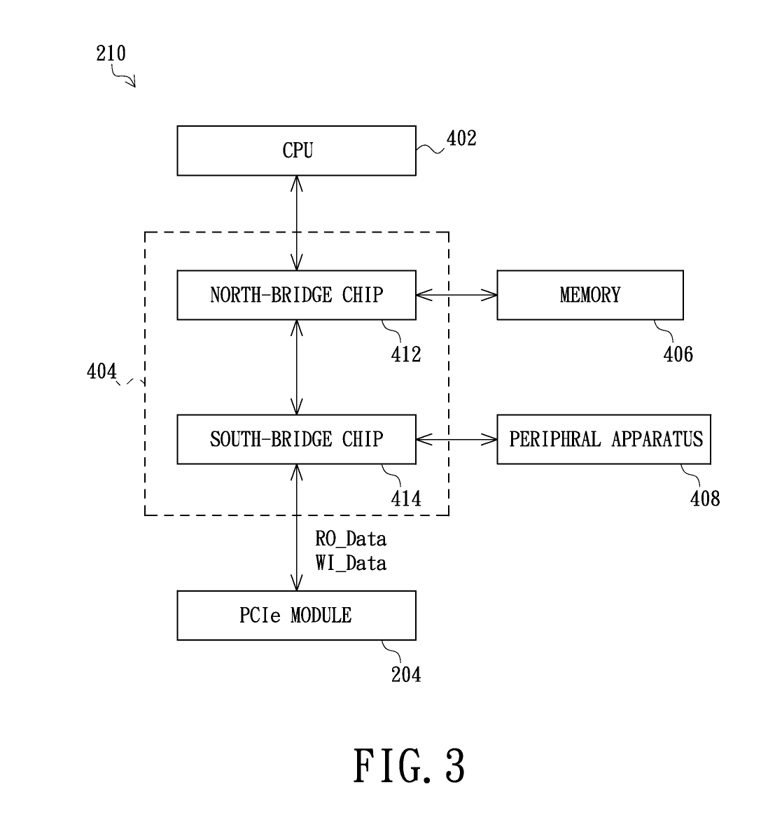

FIG. 3 is a circuit block diagram of a control module according to a preferred embodiment of the present invention. Referring to FIG. 3, the control module 210 provided in this embodiment comprises a CPU 402 and a chipset 404. Of course, it is well-known that the computer system may further include memory 406 and other peripheral apparatus 408 etc.

In some embodiments, the chipset 404 comprises a north-bridge chip 412 and a south-bridge chip 414. Wherein the north-bridge chip 412 is coupled to the CPU 402, memory 406 and south-bridge chip 414. Furthermore, the south-bridge chip 414 is coupled to the PCIe slot unit 222 in the PCIe module 204. It is well-known that the north-bridge 412 also can be coupled to the PCIe slot unit 222. In other embodiments, the north-bridge chip 412 and the south-bridge chip 414 can combine into one chip. In these embodiments, the memory 406 can be coupled to the CPU 402 directly.

In this embodiment, the read data RO_Data is transmitted to the south-bridge chip 414 of the chip set 404 first, when the control module 210 receives the same from the PCIe module 204. The read data RO_Data is then transmitted to the north-bridge chip 412 from the south-bridge chip 414. Afterwards, the read data RO Data is transmitted to the CPU 402 from the north-bridge chip 414 for further processing. Similarly, the written data WI_Data mentioned above is transmitted in a reverse route that begins at the CPU 402 and goes to the PCIe module 204.

Due to the data transmission interfaces between the card reader and the host system are all PCIe data transmission interfaces, the present invention no need data format conversion during data transmitting so as to prevent the data transmission loss and maintain data transmission speed. In addition, since the PCIe specification is a standard specification of the mother board, the technique provided by the present invention is compatible for most host systems.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A data transmission circuit, comprising:
a PCI express slot unit;
a PCI express I/O interface card, inserted into the PCI express slot unit; and
a PCI express connection device, coupled to the PCI express I/O interface card and a peripheral apparatus so as to transmit a transmission data between the peripheral apparatus and the PCI express I/O interface card through the PCI express connection device.

2. The data transmission circuit as claimed in claim 1, wherein the PCI express connection device is a PCIe bus or a flexible circuit board of PCI express specification.

3. The data transmission circuit as claimed in claim 1, wherein the peripheral apparatus is a card reader.

4. The data transmission circuit as claimed in claim 3, wherein the card reader has a PCI express port for coupling the PCI express connection device, and has at least one memory card slot with a specification conforming to at least one of specifications of memory cards.

5. A host system having a mother board with PCI express, comprising:
a control module, disposed on the mother board;
a PCI express module, disposed on the mother board, and coupled to the control module;
a PCI express connection device, coupled to the PCI express module; and
a peripheral apparatus, has a PCI express port for coupling the PCI express connection device so as to transmit a transmission data between the peripheral apparatus and the PCI express module through the PCI express connection device.

6. The host system as claimed in claim 5, wherein the peripheral apparatus is a card reader having a memory card slot conforming to at least one of specifications of memory cards.

7. The host system as claimed in claim 5, wherein the PCI express module comprises:
a PCI express slot unit, disposed on the mother board; and
a PCI express I/O interface card, inserted into the PCI express slot unit, and coupled to the peripheral apparatus through the PCI express connection device.

8. The host system as claimed in claim 5, wherein the control module comprises:
a CPU, disposed on the mother board; and
a chipset, disposed on the mother board, and coupled to the CPU and the PCI express module.

9. The host system as claimed in claim 8, wherein the chipset comprises:
a north-bridge chip, coupled to the CPU; and
a south-bridge chip, coupled to the north-bridge chip and the PCI express module.

10. The host system as claimed in claim 5, wherein the host system is a computer, a smart phone, an electronic book, a package computer, or personal digital assistant.
